(19) United States
(12) Patent Application Publication
(10) Pub. No.: US 2022/0220921 A1
(43) Pub. Date: Jul. 14, 2022

(54) PASSIVE PRECHAMBER LEAN BURN COMBUSTION SYSTEM

(71) Applicant: SAUDI ARABIAN OIL COMPANY, Dhahran (SA)

(72) Inventor: Nayan Engineer, Canton, MI (US)

(73) Assignee: ARAMCO SERVICES COMPANY, Houston, TX (US)

(21) Appl. No.: 17/145,718

(22) Filed: Jan. 11, 2021

(51) Int. Cl. F02F 3/26; F02B 23/06; F02B 3/06; F02B 19/14

(52) U.S. Cl. CPC F02F 3/26; F02B 23/0627; F02B 2075/125; F02B 19/14; F02B 23/0645; F02B 3/06

(57) ABSTRACT

A combustion system includes a cylinder having a main chamber and a fuel injector positioned to inject fuel into the main chamber. A cylinder head is disposed at a top of the cylinder and forms an upper end of the main chamber. A prechamber adapter has a prechamber volume and a nozzle with a plurality of orifices for communication between the prechamber volume and an external environment. The prechamber adapter is threaded into a bore in the cylinder head and positioned to expose the nozzle to the main chamber. A spark plug is positioned within the prechamber adapter with a spark emitting end exposed to the prechamber volume. A piston movably disposed within the cylinder has a piston head forming a lower end of the main chamber. The piston head has a dome shape and a bowl formed in a top center of the dome shape.

### BACKGROUND

One important avenue for improving gasoline engine efficiency is to operate the engine as lean burn, i.e., more air is burnt for a given amount of fuel. Currently, spark ignited gasoline engines use a spark discharge to initiate combustion inside a main chamber of a cylinder. However, standard spark plugs are unable to provide a strong enough arc to burn a lean mixture, resulting in misfire or no-burn condition when the engine is run very lean.

Turbulent jet ignition has been proposed as a strategy to ignite a lean mixture in a main chamber. In turbulent jet ignition, a prechamber is used to combust a small quantity of fuel. The burn moves from the prechamber into the main chamber in the form of rich radicals that are hot and have high velocities to penetrate deep into the main chamber and ignite the lean charge in the main chamber. The volume between the prechamber and the main chamber and the size and geometry of the orifice of the prechamber are critical, which make integration of the prechamber into existing engine designs challenging.

### SUMMARY

In a first summary example, a combustion system includes a cylinder having a main chamber and a cylinder head disposed at a top of the cylinder. The cylinder head forms an upper end of the main chamber. The combustion system includes a prechamber adapter having a prechamber volume defined therein and a nozzle formed at a distal end thereof. The nozzle includes a plurality of orifices fluidly connecting the prechamber volume to an external environment of the nozzle. The prechamber adapter is threaded into a bore in the cylinder head and positioned in the cylinder head to expose the nozzle to the main chamber. The combustion system includes a spark plug that is positioned within the prechamber adapter. A spark emitting end of the spark plug is exposed to the prechamber volume. A piston is disposed within the cylinder and movable between a top dead center position and a bottom dead center position. The piston has a piston head forming a lower end of the main chamber. The piston head has a dome shape and a bowl formed in a top center of the dome shape. The bowl selectively carries a charge to the nozzle. The combustion system includes a fuel injector that is positioned to inject fuel into the main chamber. In certain cases, the plurality of orifices of the nozzle may be positioned radially relative to a main axis of the prechamber adapter and circumferentially spaced apart around the nozzle. In certain cases, the prechamber adapter may be centrally positioned relative to the main chamber. In certain cases, the spark plug may be centrally positioned within the prechamber adapter. In certain cases, the bowl may have a shape and size to receive at least a portion of the nozzle and form a wall around the at least a portion of the nozzle. In certain cases, the at least a portion of the nozzle may include the plurality of orifices. In certain cases, the fuel injector may be positioned to inject fuel directly into the main chamber. In certain cases, the fuel injector may be oriented to spray fuel in a direction towards the bowl when the piston is at a select location between the bottom dead center position and the top dead center position. In certain cases, the combustion system may further include an intake port formed in the cylinder head and an additional fuel injector positioned to inject fuel into the main chamber through the intake port. In certain cases, the prechamber adapter may be positioned in the cylinder head to extend the nozzle below the cylinder head and into the main chamber.

In a second summary example, a method of combustion includes capturing a combustible mixture in a bowl formed at a top center of a dome-shaped piston head of a piston inside a cylinder. The method includes moving the piston relative to the cylinder to carry the combustible mixture to a nozzle of a prechamber adapter mounted at a cylinder head. The method includes communicating at least a portion of the combustible mixture to a prechamber volume inside the prechamber adapter through a plurality of orifices of the nozzle. The method includes operating a spark plug centrally positioned within the prechamber adapter to ignite the combustible mixture inside the prechamber volume. In certain cases, the method may include supplying fuel and air into a main chamber formed between the piston head and the cylinder head, and the act of capturing the combustible mixture in the bowl may include capturing a portion of the fuel and air in the bowl. In certain cases, the act of capturing the combustible mixture in the bowl may include spraying fuel into the bowl using a fuel injector positioned to inject fuel directly into the main chamber. In certain cases, the act of moving the piston relative to the cylinder to carry the combustible mixture to the nozzle of the prechamber adapter may include moving the piston in a direction towards the cylinder head until at least a portion of the nozzle enters the bowl. In certain cases, the act of moving the piston relative to the cylinder to carry the combustible mixture to the nozzle of the prechamber adapter may include compressing the fuel and air in the main chamber.

In a third summary example, a prechamber device includes a prechamber adapter having a main axis. The prechamber adapter includes an adapter body having an internal bore extending along the main axis, an internal surface having an internal surface threaded portion, and an external surface having an external surface threaded portion. The prechamber adapter includes a nozzle disposed at an end of the adapter body. The nozzle has an internal chamber fluidly connected to the internal bore and a plurality of orifices fluidly connecting the internal chamber to an external environment of the nozzle. The prechamber adapter includes a spark plug centrally positioned within the internal bore and having a spark emitting end exposed to the internal chamber. The spark plug is threadedly engaged with the internal surface threaded portion. In certain cases, the plurality of orifice are radially oriented relative to the main axis and circumferentially spaced apart around the nozzle. In certain cases, the adapter body and nozzle are integrated to form a single-piece structure. In certain cases, the internal surface threaded portion has a metric thread size of M10, and the external surface threaded portion has a metric thread size of M14. In certain cases, the nozzle has a tapered shape.

The foregoing general description and the following detailed description are exemplary of the invention and are intended to provide an overview or framework for understanding the nature of the invention as it is claimed. The accompanying drawings are included to provide further understanding of the invention and are incorporated in and constitute a part of the specification. The drawings illustrate various embodiments of the invention and together with the description serve to explain the principles and operation of the invention.

### BRIEF DESCRIPTION OF DRAWINGS

The following is a description of the figures in the accompanying drawings. In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 is a cross-sectional view of a prechamber adapter.

FIG. 2 is a cross-sectional view of a passive prechamber device employing the prechamber adapter of FIG. 1.

FIG. 3 is a cross-sectional view of a portion of an engine incorporating the passive prechamber device of FIG. 2.

FIG. 4A is a perspective view of piston head with a bowl.

FIG. 4B is a schematic diagram of a swirl motion relative to a piston with a bowl.

FIGS. 5A-5D are schematic diagrams illustrating examples of bowl geometries.

FIG. 6 is a schematic diagram illustrating a prechamber adapter nozzle received in a piston head bowl.

FIG. 7A is a schematic diagram illustrating the beginning of an intake stroke of the engine shown in FIG. 3.

FIG. 7B is a schematic diagram illustrating the beginning of a compression stroke of the engine shown in FIG. 3.

FIC. 7C is a schematic diagram illustrating spraying of fuel into a piston head bowl during a compression stroke of the engine shown in FIG. 3.

FIG. 7D is a schematic diagram illustrating a prechamber adapter nozzle entering a piston head bowl during a compression stroke of the engine shown in FIG. 3.

FIG. 7E is a schematic diagram illustrating a piston head bowl disposed around orifices of a prechamber adapter nozzle at or near the end of a compression stroke of the engine shown in FIG. 3.

FIG. 7F is a schematic diagram illustrating the beginning of an exhaust stroke of the engine shown in FIG. 3.

### DETAILED DESCRIPTION

In the following detailed description, certain specific details are set forth in order to provide a thorough understanding of various disclosed implementations and embodiments. However, one skilled in the relevant art will recognize that implementations and embodiments may be practiced without one or more of these specific details, or with other methods, components, materials, and so forth. In other instances, related well known features or processes have not been shown or described in detail to avoid unnecessarily obscuring the implementations and embodiments. For the sake of continuity, and in the interest of conciseness, same or similar reference characters may be used for same or similar objects in multiple figures.

A prechamber adapter that enables installation of a passive prechamber in existing engines with minimal to no modification to the engines is described. The prechamber adapter may be used to centrally position a passive prechamber relative to a main chamber of an engine cylinder. A combustion system employing a centrally positioned passive prechamber is described. Also described is a piston head bowl that together with the centrally positioned passive prechamber enables lean combustion in the main chamber with good efficiency.

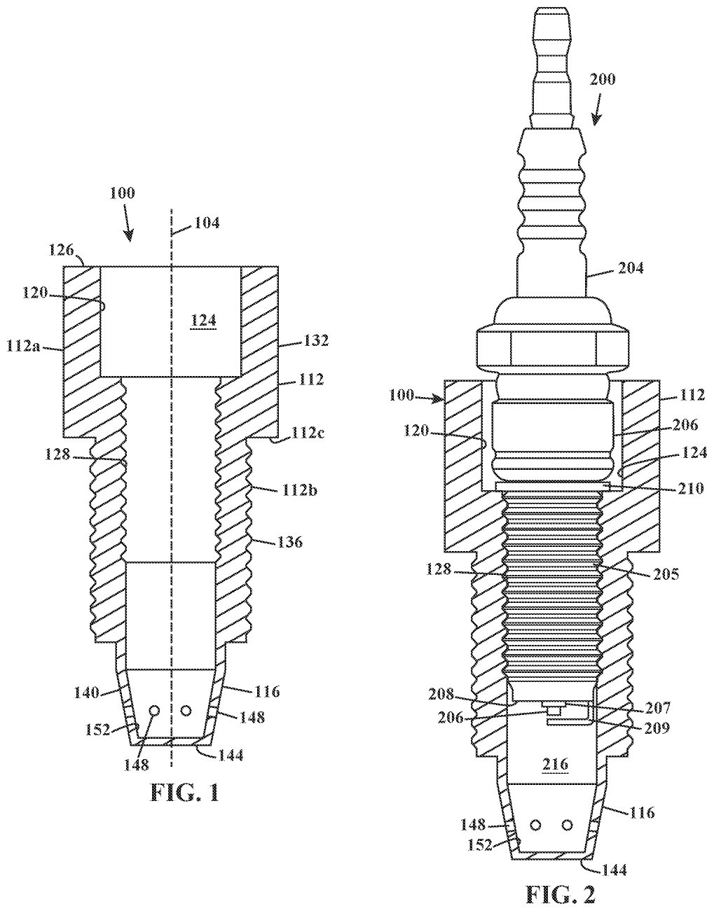

FIG. 1 shows an illustrative implementation of a prechamber adapter 100 that may be mounted in a bore in a cylinder head. Prechamber adapter 100 has a main axis 104, which may be a longitudinal axis. Prechamber adapter 100 includes an adapter body 112 and a nozzle 116 disposed at an end of adapter body 112. Adapter body 112 and nozzle 116 are axially aligned along main axis 104. In one implementation, nozzle 116 is formed integrally with adapter body 112 or permanently attached to adapter body 112, e.g., by welding, to form a single-piece structure. Integral forming means that there is no seam between adapter body 112 and nozzle 116. Prechamber adapter 100 may be made of a metal or an alloy that can withstand high temperatures that would be encountered during combustion. In one example, prechamber adapter 100 may be made of steel. The cylinder head will typically be made of aluminum. Typically, both prechamber adapter 100 and the cylinder head will have cooling water around them to control their temperatures. In one example, adapter body 112 includes a larger diameter cylindrical section 112a and a smaller diameter cylindrical section 112b. A shoulder 112c is formed in a transition area between sections 112a, 112b. Nozzle 116 may be attached to smaller diameter cylindrical section 112b.

Adapter body 112 has an internal surface 120 forming an internal bore 124. In one example, internal bore 124 extends along main axis 104 and is accessible from an upper end 126 of adapter body 112. Internal surface 120 includes an internal surface threaded portion 128. In one example, the threads in internal surface threaded portion 128 are selected to mate with complementary threads on a spark plug. In one example, internal surface threaded portion 128 has a metric thread size of M10 to mate with 10 mm thread spark plugs. Adapter body 112 has an external surface 132, which includes an external surface threaded portion 136. In one example, external surface threaded portion 136 may be located on smaller diameter cylindrical section 112b. In one example, the threads in external surface threaded portion 136 are selected to mate with complementary threads of a bore in a cylinder head. In one example, external surface threaded portion 136 has a metric thread size of M14 to mate with a 14 mm threaded bore in a cylinder head. In general, the threads on internal surface threaded portion 128 may be different from the threads on external surface threaded portion 136. Shoulder 112c on adapter body 112 may serve to limit travel of the prechamber adapter when the adapter body 112 is being threaded into the bore of the cylinder head, e.g., shoulder 112c may engage a seat at the inlet of the bore.

Nozzle 116 has a side wall 140 and an end wall 144. End wall 144 forms a terminus of prechamber adapter 100. End wall 144 is shown as a planar wall. However, it could be a non-planar wall, e.g., a curved or beveled wall, in other examples. Side wall 140 may be a tapered cylindrical wall, giving nozzle 116 a tapered shape. The tapering of nozzle 116 may be in a direction towards end wall 144, or the terminus of prechamber adapter 100. In some cases, side wall 140 may be a straight cylindrical wall. Nozzle 116 has an internal chamber 152 defined by walls 140, 144. Internal chamber 152 is fluidly connected to internal bore 124 in adapter body 112. Orifices 148 are formed in side wall 140 and form fluid paths between internal chamber 152 and an external environment of the nozzle. In one implementation, orifices 148 are circumferentially spaced apart around nozzle 116 and are radially oriented relative to main axis 104. Although not shown, in some cases, orifices may be provided in end wall 144 to form fluid paths between internal chamber 152 and the external environment.

FIG. 2 shows a passive prechamber device 200 including a spark plug 204 received partially inside internal bore 124 of prechamber adapter 100. Spark plug 204 can be any conventional spark plug known in the art. In general, spark plug 204 may include a threaded shell 205 and a central electrode 206 disposed inside shell 205. An electrical insulator 207 extends into shell 205 and isolates shell 205 from central electrode 206. Central electrode 206 protrudes from electrical insulator 207 at a spark emitting end 208 of the spark plug. A ground electrode 209 is positioned at spark emitting end 208 and separated from central electrode 206 by a gap. In one example, spark plug 204 may be a 10 mm thread spark plug, also known as M10 spark plug, which means that the threads on threaded shell 205 will have a metric thread size of M10. Spark plug 204 is supported inside internal bore 124 of prechamber adapter 100 by engaging the threads of threaded shell 105 with the threads of internal threaded portion 128 of adapter body 112. A washer 210 may provide a sealing interface between spark plug 204 and prechamber adapter 100.

In one implementation, spark plug 204 is centrally positioned within prechamber adapter 100, which means that spark plug 204 is coaxial with prechamber adapter 100. Spark emitting end 208 is in opposing relation to end wall 144 of nozzle 116 and forms an upper part of a prechamber volume 216. End wall 144 of nozzle 116 forms a lower part of prechamber volume 216. As shown, at least a part of prechamber volume 216 occupies internal chamber 152 within nozzle 116. Electrodes 206, 209 at spark emitting end 208 are exposed to prechamber volume 216.

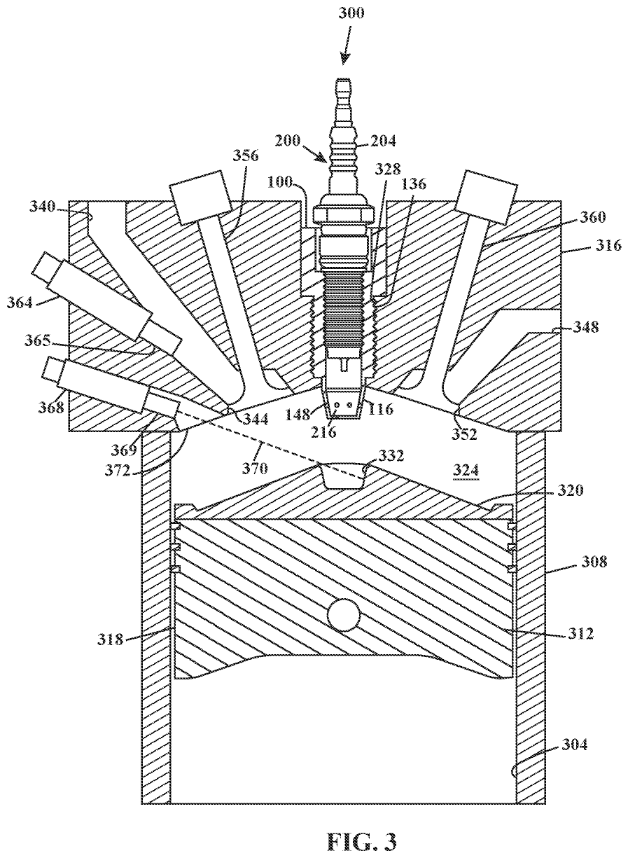

FIG. 3 shows a combustion system 300 incorporating passive prechamber device 200. Combustion system 300 includes a cylinder 304 formed within an engine body or engine block 308 (only a portion of the engine block is shown, and only one cylinder in the engine block is shown—an engine block may have several cylinders). A piston 312 is arranged to move back and forth (or up and down) within cylinder 304, typically between a top dead center (TDC) and a bottom dead center (BDC). TDC is the position of the piston when the piston is at the top of its stroke, and BDC is the position of the piston when the piston is at the bottom of its stroke. Piston 312 may be connected to a crankshaft (not shown) by a connecting rod (not shown). The crankshaft will convert the reciprocating motion of piston 312 into rotary motion, as is well known in the art. A cylinder head 316 is mounted at the top of cylinder 304 (only a portion of the cylinder head is shown). Piston 312 has a cylindrical piston body 318 and a piston head 320 formed on top of cylindrical piston body 318. Piston head 320 is in opposing relation to cylinder head 316. Cylinder 308 includes a main chamber 324 for combustion of a fuel-air mixture. Piston head 320 forms a lower end of main chamber 324, and cylinder head 316 forms an upper end of main chamber 324.

Passive prechamber device 200 is mounted to cylinder head 316. In one example, cylinder head 316 includes a threaded bore 328, and passive prechamber device 200 is mounted to cylinder head 316 by making up a threaded connection between threaded bore 328 and external surface threaded portion 136 on prechamber adapter 100. Threaded bore 328 opens to main chamber 324 such that when the threaded connection is made up, nozzle 116 is exposed to main chamber 324. In one example, nozzle 116 extends below cylinder head 316 into main chamber 324 such that orifices 148 of nozzle 116 are positioned within main chamber 324. In one implementation, the arrangement of passive prechamber device 200 in cylinder head 316 is such that prechamber volume 216 and spark plug 204 are centrally positioned relative to main chamber 324. This may be achieved, for example, by aligning the main axis of prechamber adapter 100 with the axial axis (or piston axis) of piston 312 (or the axial axis of cylinder 304), as shown. In this case, nozzle 116 is also centrally positioned relative to main chamber 324.

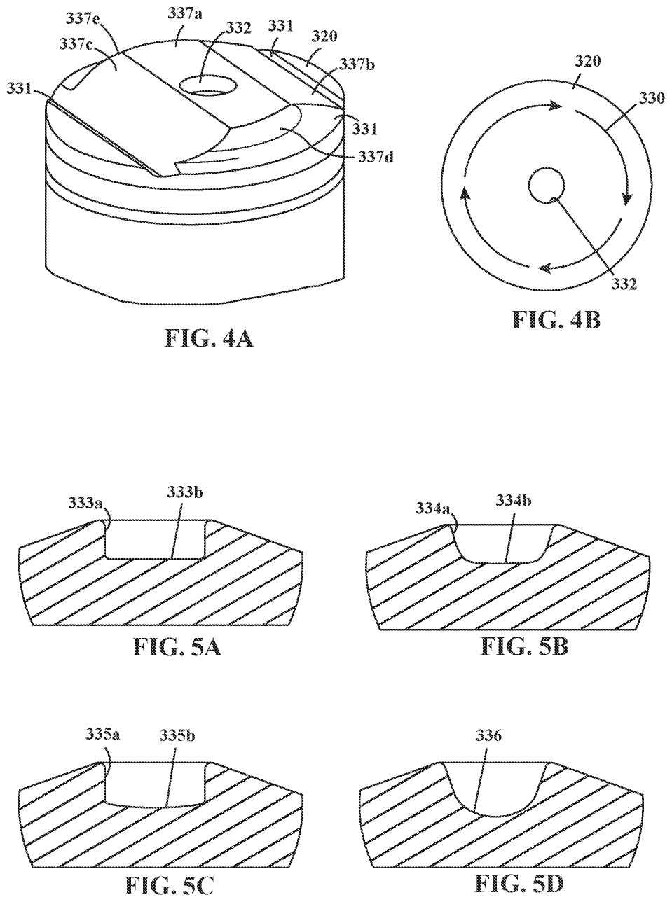

In one implementation, piston head 320 has a dome shape. A bowl 332, i.e., a concave depression, is formed at the top center of the dome shape of piston head 320. As more clearly shown in FIG. 4A, bowl 332 is centrally located on piston head 320. Bowl 332 is used to carry a charge to the prechamber nozzle during an engine cycle. Examples of bowl geometries are shown in FIGS. 5A-5D. The bowl geometry shown in FIG. 5A has a straight cylindrical side wall 333a and a flat bottom wall 333b. The bowl geometry shown in FIG. 5B has a tapered cylindrical side wall 334a and a flat bottom wall 334b. In FIG. 5C, the bowl geometry has a straight cylindrical side wall 335a and a curved bottom wall 335b. In FIG. 5D, the bowl geometry has a continuous curved wall 336. Any of the geometries shown in FIGS. 5A-5D may form the basis for optimizing the bowl geometry for the purposes of providing the prechamber nozzle with a charge. In some cases, the bowl geometry may be influenced by the shape of the prechamber nozzle. Additional recessed areas, indicated as 331 in FIG. 4A, for example, may be formed in piston head 320. These recessed areas may play a role in the flow dynamics inside the main chamber as well as reduce the volume of the cylinder taken up by the dome shape of the piston head.

The shape of the piston dome can be adjusted to achieve a desired compression ratio, which is important when tuning the combustion system to achieve efficient and clean combustion. Compression ratio is the maximum volume of the combustion chamber (main chamber volume and prechamber volume), i.e., when the piston is at BDC, divided by the volume when the piston is in the full-compression position, i.e., when the piston is at TDC. For example, given an initial piston dome design such as shown in FIG. 4A, surface 337a where bowl 332 is formed can be moved up (i.e., the height of surface 337a on the piston head increased) to increase the compression ratio or moved down (i.e., the height of surface 337a on the piston head decreased) to decrease the compression ratio. When moving up surface 337a to increase compression ratio, surfaces 337b, 337c adjacent to surface 337a are not moved up so that they do not interfere with the engine cylinder valves during operation. In addition, surfaces 337d, 337e (surface 337e is in opposing relation to 337d) may be moved outboard to adjust compression ratio. In general, surfaces 337a-337e can be suitably adjusted to achieve a desired compression ratio while preventing interference of the piston head surfaces with the engine cylinder valves during operation.

Returning to FIG. 3, intake air entering into main chamber 324 creates a swirl in main chamber 324. The swirl is useful in mixing fuel and air inside the main chamber. The higher the engine load, the stronger the swirl may be as more air is admitted into the main chamber. Arrows 330 in FIG. 4B illustrate a swirl motion that may occur in the main chamber relative to piston head 320. As shown, the swirl moves in a clockwise fashion around the piston axis and therefore around bowl 332. The swirl motion can have the effect of sweeping a charge (i.e., a mixture of fuel and air) toward bowl 332. The dome shape of piston head 320 can enable the swirl motion to keep the charge concentrated at and above bowl 332 until the upward motion of piston 312 moves bowl 332 to the prechamber nozzle.

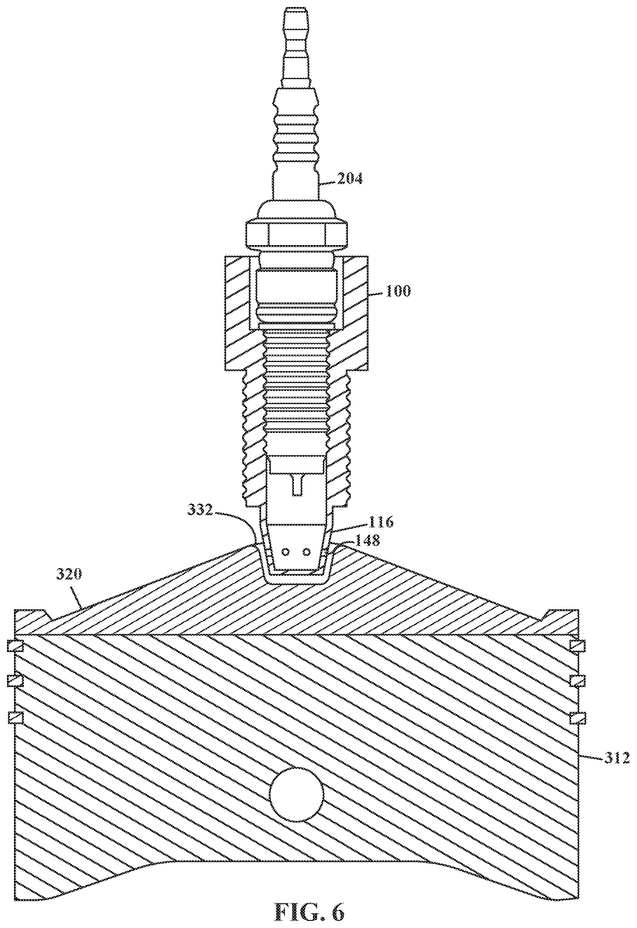

In one example, as illustrated in FIG. 6, bowl 332 may be shaped and sized such that at least a portion of nozzle 116 can be received inside bowl 332 during upward motion of the piston. In one example, the positioning of nozzle 116 may be such that at least a portion of nozzle 116 is received inside bowl 332 when piston 312 is at TDC. In one case, the portion of nozzle 116 received inside bowl 332 may include orifices 148 such that bowl 332 circumscribes orifices 148. When nozzle 116 is received inside bowl 332, the side wall of bowl 332 will guide the charge to orifices 148. For example, a flow column will form between the side wall of bowl 332 and the side wall of nozzle 116 from which flow can enter into orifices 148. The angle of the side wall of bowl 332 (or the shape of bowl 332) and the annular gap between the side wall of bowl 332 and the side wall of nozzle 116 may be suitably selected to achieve a desired flow pattern of the charge around orifices 148. In practice, the piston will “rock” at TDC position. Therefore, the gap between the side wall of bowl 332 and the side wall of nozzle 116 should not be too tight that there would be physical contact between bowl 332 and nozzle 116 due to rocking motion of the piston. Typically, a gap of about 2 mm all around nozzle 116 will suffice, but this is not intended to be limiting.

Returning to FIG. 3, cylinder head 316 includes an intake passage 340 terminating in an intake port 344. Cylinder head 316 includes an exhaust passage 348 terminating in an exhaust port 352. Intake port 344 and exhaust port 352 are in the part of cylinder head 316 forming an upper end of main chamber 324. An intake valve 356 is arranged to control opening and closing of intake port 344. When intake port 344 is open, air can be drawn into main chamber 324 from intake passage 340. Although not shown, intake passage 340 is connected to a source of air in a conventional manner. The air in intake passage 340 may be ambient air or a mixture of ambient air and recirculated exhaust gases. A valve not shown may be positioned to control flow of air into intake passage 340. An exhaust valve 360 is arranged to control opening and closing of exhaust port 352. When exhaust port 352 is open, exhaust gases can be pushed out of main chamber 324 into exhaust passage 348. Opening and closing of valves may be controlled by an engine control unit (not shown separately) according to an engine operation plan.

A fuel injector 364 is mounted in cylinder head 316 and has a nozzle 365 exposed to intake passage 340. Fuel injector 364 can be operated to inject fuel into the air flowing along intake passage 340 to intake port 344. The intake air will entrain the injected fuel and enter main chamber 324 if intake valve 356 is in the open position. Fuel injector 364 may be described as a port injector. A fuel injector 368 is mounted in cylinder head 316 and has a nozzle 369 exposed directly to main chamber 324 through an opening 372 in the part of cylinder 316 forming an upper end of main chamber 324. In some cases, nozzle 369 may be exposed directly to main chamber 324 through an opening at a side of cylinder 304. Fuel injector 368 may be described as a direct injector. In one example, fuel injector 368 may be oriented such that there is at least one piston position between BDC and TDC where there is a line of sight 370 (dashed line) between nozzle 369 and bowl 332 that allows fuel injector 368 to spray fuel directly into bowl 332 (or in the direction of bowl 332). Operation of fuel injectors 364, 368 may be controlled by the engine control unit according to an engine operation plan.

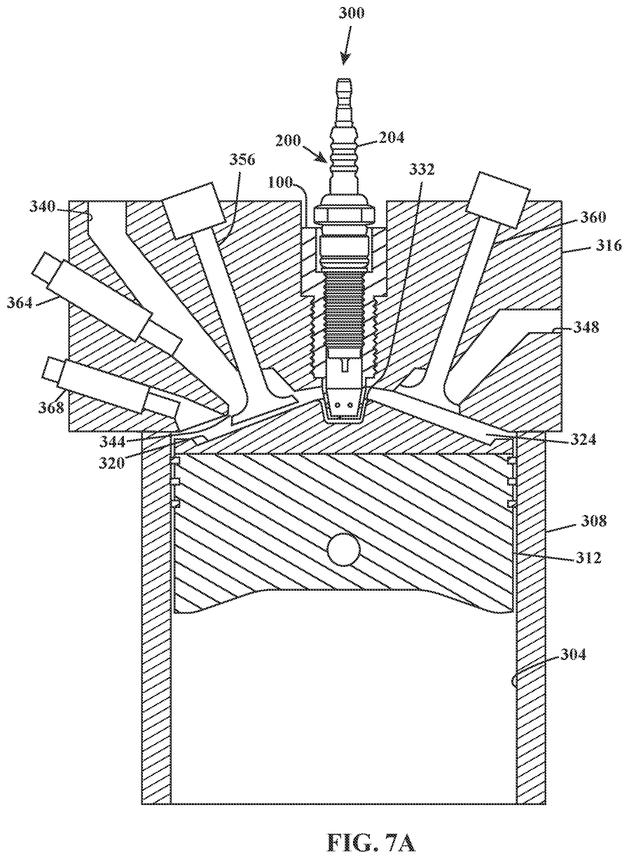

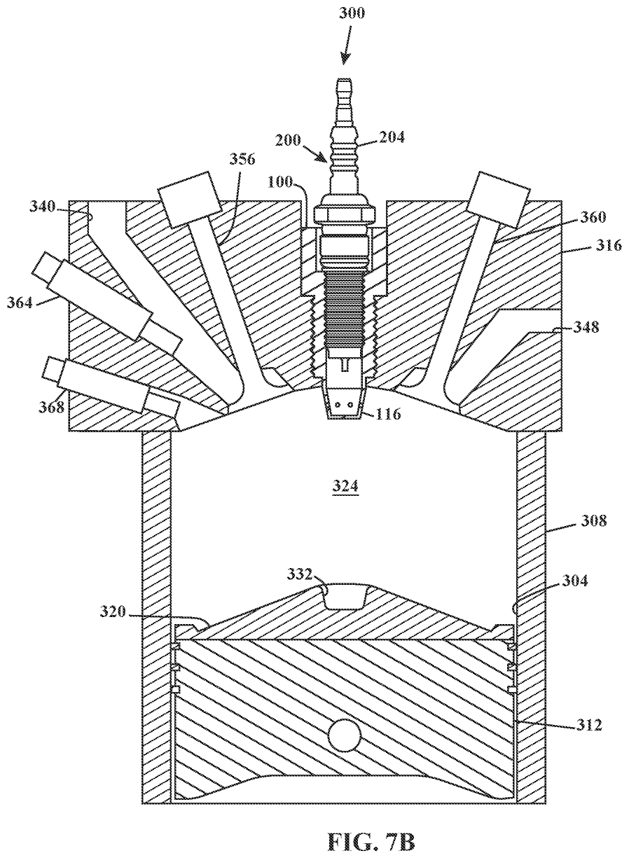

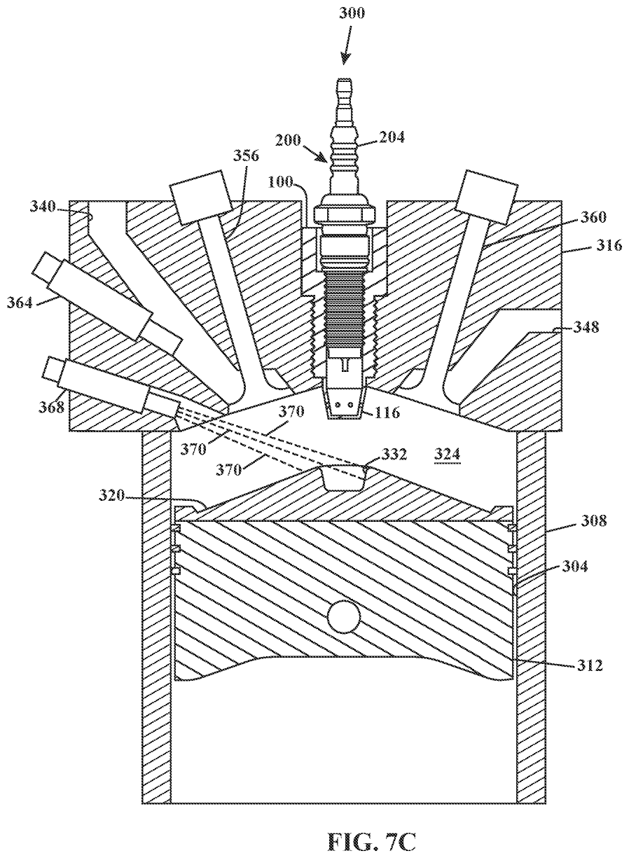

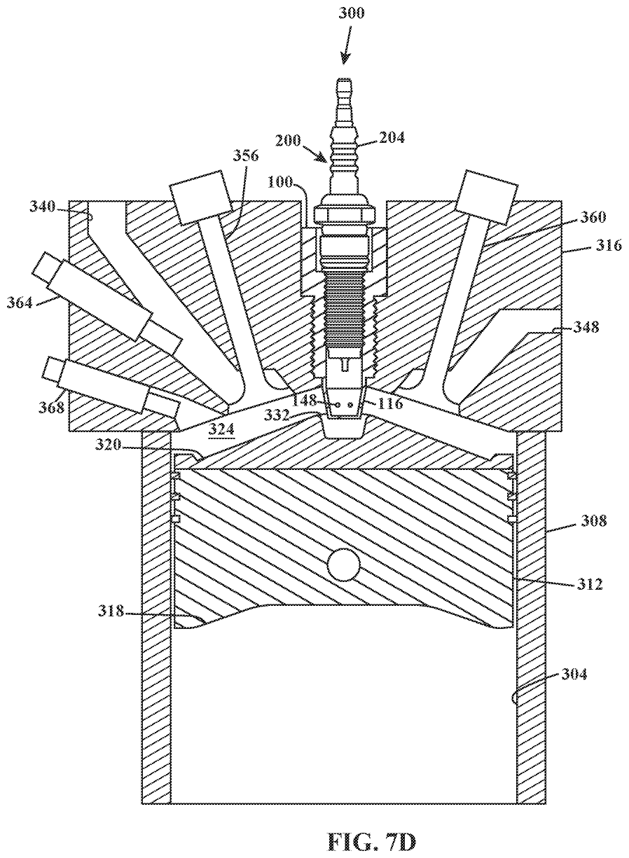

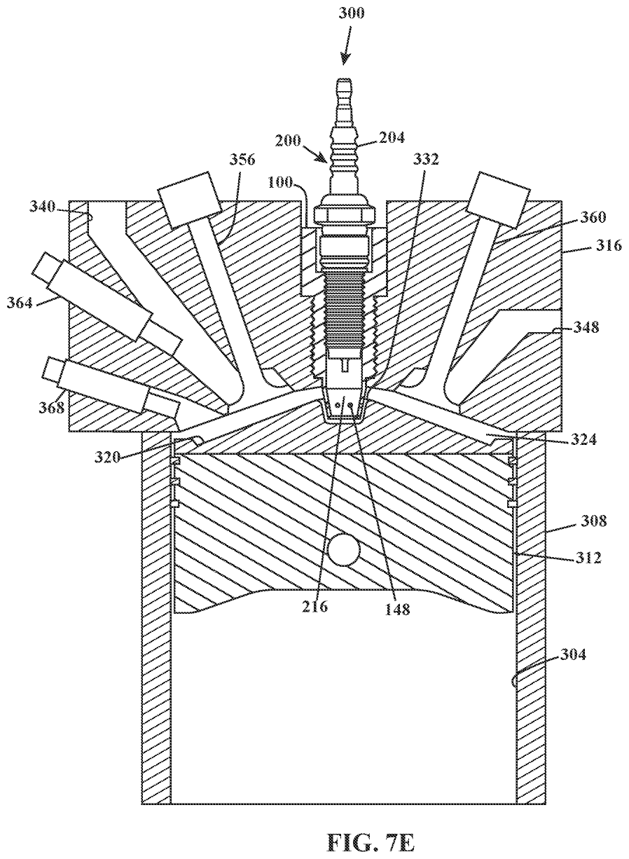

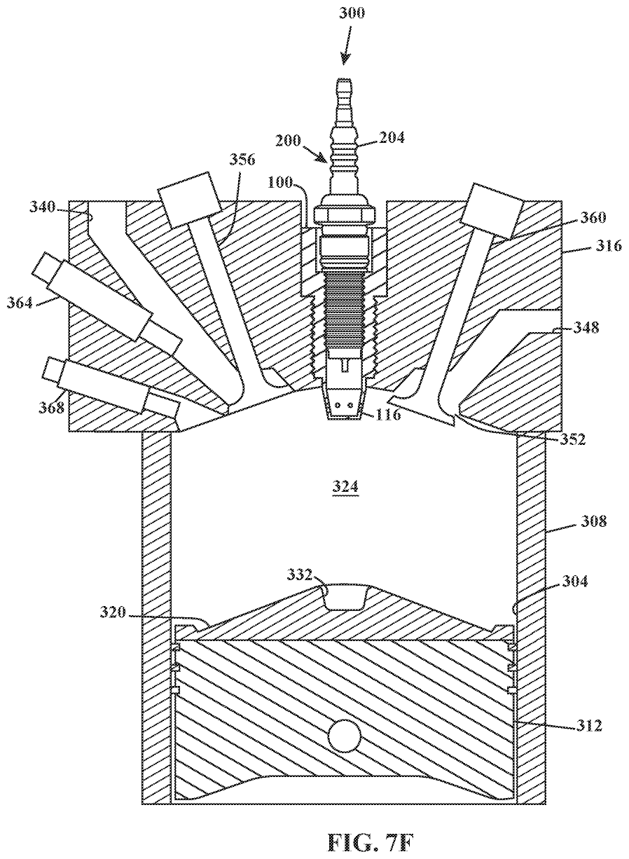

In one example, the engine operates the cylinder on a four-stroke cycle including an intake stroke, a compression stroke, a power stroke, and an exhaust stroke. At the beginning of the intake stroke, intake valve 356 is open, exhaust valve 360 is closed, and piston 312 is at TDC, as shown in FIG. 7A. As piston 312 moves away from TDC, air in intake passage 340 is drawn into main chamber 324 through intake port 344. Fuel injector 364 may be operated to inject fuel into the air that is drawn into main chamber 324 through intake port 344. Optionally, injector 368 may be operated to inject fuel into main chamber 324. The motion of piston 312 may cause mixing of the air and fuel supplied into main chamber 324. The swirl action created by the air inside main chamber 324 helps with mixing the air and fuel. The dome shape of piston head 320 may help with improving homogeneity of the fuel-air mixture. Some of the fuel-air mixture inside main chamber 324 will enter bowl 332 in piston head 320. When piston 312 reaches BDC, intake valve 356 closes.

At the beginning of the compression stroke, as shown in FIG. 7B, piston 312 is at BDC and intake valve 356 and exhaust valve 360 are closed. Piston 312 starts to move towards TDC, compressing the fuel-air mixture inside main chamber 324. As piston 312 moves towards TDC, bowl 332 carries a charge of fuel and air towards nozzle 116 of prechamber device 200. In one example, when piston 312 is at a predetermined position between TDC and BDC where fuel can be sprayed directly into bowl 332, fuel injector 368 is operated to spray fuel into bowl 332, as illustrated in FIG. 7C along lines of sight 370 (dashed lines), thereby increasing the richness of the fuel-air mixture inside bowl 332. As piston 312 approaches TDC, nozzle 116 enters bowl 332, as shown in FIG. 7D. At TDC, a portion of nozzle 116 including orifices 148 may be fully inside bowl 332 so that the side wall of bowl 332 wraps around orifices 148, as shown in FIG. 7E. The side wall of bowl 332 will guide the charge carried by bowl 332 to orifices 148, allowing filling of prechamber volume 216 with the charge.

Prior to or close to the end of the compression stroke, spark plug 204 is fired, igniting the charge in prechamber volume 216. The spark timing is such that turbulent jets emanate from nozzle 116 as piston 312 moves outward, i.e., in a direction away from cylinder head 316 or towards the bottom of cylinder 304, on the power stroke. The turbulent jets ignite the lean charge in main chamber 324. High pressure gases produced from combustion of the charge in main chamber 324 will expand and push piston 312 down and towards BDC, generating force on the crank and shaft and useful work. When piston 312 is at BDC, exhaust valve 360 opens to begin the exhaust stroke, as shown in FIG. 7F. During the exhaust stroke, piston 312 pushes exhaust gases out of main chamber 324 into exhaust passage 348 through exhaust port 352.

The detailed description along with the summary and abstract are not intended to be exhaustive or to limit the embodiments to the precise forms described. Although specific embodiments, implementations, and examples are described herein for illustrative purposes, various equivalent modifications can be made without departing from the spirit and scope of the disclosure, as will be recognized by those skilled in the relevant art.

1. A combustion system comprising:
a cylinder including a main chamber;
a cylinder head disposed at a top of the cylinder and forming an upper end of the main chamber;
a prechamber adapter having a prechamber volume defined therein and a nozzle formed at a distal end thereof, the nozzle having a plurality of orifices fluidly connecting the prechamber volume to an external environment of the nozzle, the prechamber adapter threaded into a bore in the cylinder head and positioned in the cylinder head to expose the nozzle to the main chamber;
a spark plug positioned within the prechamber adapter and having a spark emitting end exposed to the prechamber volume;
a piston disposed within the cylinder and movable between a top dead center position and a bottom dead center position, the piston having a piston head forming a lower end of the main chamber, the piston head having a dome shape and a bowl formed in a top center of the dome shape, the bowl to selectively carry a charge to the nozzle; and
a fuel injector positioned to inject fuel into the main chamber.

2. The combustion system of claim 1, wherein the plurality of orifices are radially positioned relative to a main axis of the prechamber adapter and circumferentially spaced apart around the nozzle.

3. The combustion system of claim 2, wherein the prechamber adapter is centrally positioned relative to the main chamber.

4. The combustion system of claim 2, wherein the spark plug is centrally positioned within the prechamber adapter.

5. The combustion system of claim 2, wherein the bowl has a shape and size to receive at least a portion of the nozzle and form a wall around the at least a portion of the nozzle.

6. The combustion system of claim 5, wherein the at least a portion of the nozzle includes the plurality of orifices.

7. The combustion system of claim 5, wherein the fuel injector is positioned to inject fuel directly into the main chamber.

8. The combustion system of claim 7, wherein the fuel injector is oriented to spray fuel in a direction towards the bowl when the piston is at a select location between the bottom dead center position and the top dead center position.

9. The combustion system of claim 7, further comprising an intake port formed in the cylinder head and an additional fuel injector positioned to inject fuel into the main chamber through the intake port.

10. The combustion system of claim 1, wherein the prechamber adapter is positioned in the cylinder head to extend the nozzle below the cylinder head and into the main chamber.

11. A method of combustion, the method comprising:
capturing a combustible mixture in a bowl formed at a top center of a dome-shaped piston head of a piston inside a cylinder;
moving the piston relative to the cylinder to carry the combustible mixture to a nozzle of a prechamber adapter mounted at a cylinder head;
communicating at least a portion of the combustible mixture to a prechamber volume inside the prechamber adapter through a plurality of orifices of the nozzle; and
operating a spark plug centrally positioned within the prechamber adapter to ignite the combustible mixture inside the prechamber volume.

12. The method of claim 11, further comprising supplying fuel and air into a main chamber formed between the piston head and the cylinder head, wherein capturing the combustible mixture in the bowl includes capturing a portion of the fuel and air in the bowl.

13. The method of claim 12, wherein capturing the combustible mixture in the bowl further includes spraying fuel into the bowl using a fuel injector positioned to inject fuel directly into the main chamber.

14. The method of claim 12, wherein moving the piston relative to the cylinder to carry the combustible mixture to the nozzle of the prechamber adapter comprises moving the piston in a direction towards the cylinder head until at least a portion of the nozzle enters the bowl.

15. The method of claim 12, wherein moving the piston relative to the cylinder to carry the combustible mixture to the nozzle of the prechamber adapter comprises compressing the fuel and air in the main chamber.

16. A prechamber device comprising:
a prechamber adapter having a main axis, the prechamber adapter comprising:
an adapter body having an internal bore extending along the main axis, an internal surface having an internal surface threaded portion, and an external surface having an external surface threaded portion; and
a nozzle disposed at an end of the adapter body, the nozzle having an internal chamber fluidly connected to the internal bore and a plurality of orifices fluidly connecting the internal chamber to an external environment of the nozzle; and
a spark plug centrally positioned within the internal bore and having a spark emitting end exposed to the internal chamber, the spark plug threadedly engaged with the internal surface threaded portion.

17. The prechamber device of claim 16, wherein the plurality of orifices are radially oriented relative to the main axis and circumferentially spaced apart around the nozzle.

18. The prechamber device of claim 16, wherein the adapter body and nozzle are integrated to form a single-piece structure.

19. The prechamber device of claim 16, wherein the internal surface threaded portion has a metric thread size of M10 and the external surface threaded portion has a metric thread size of M14.

20. The prechamber device of claim 16, wherein the nozzle has a tapered shape.
